(19) United States
(12) Patent Application Publication
(10) Pub. No.: US 2025/0173170 A1
(43) Pub. Date: May 29, 2025

(54) SYSTEMS AND METHODS FOR AUTOMATICALLY GENERATING CONTEXTUALIZED VISUALIZATIONS

(71) Applicant: The Toronto-Dominion Bank, Toronto (CA)

(72) Inventors: Nolan GLYNN-UDROW, Toronto (CA); Ana Vitoria Joly HULSHOF, Toronto (CA); Tonja Selena LAUNEN, Toronto (CA); Melissa STEWART, Charlotte, NC (US)

(21) Appl. No.: 18/960,179

(22) Filed: Nov. 26, 2024

Related U.S. Application Data
(60) Provisional application No. 63/603,530, filed on Nov. 28, 2023.

(51) Int. Cl. G06F 9/451; G06F 16/23

(52) U.S. Cl. CPC G06F 9/451; G06F 16/23

(57) ABSTRACT

Systems and methods for generating contextualized data visualizations. A first graphical user interface (GUI) object based on first data is provided, along with a second GUI object based on the second data. A user may select a scenario to be analyzed and, in response to the single selection of the scenario, the system models a first impact of the scenario on the first data to generate predicted first data and separately models a second impact of the scenario on the second data to generate predicted second data. The predicted data may be generated by an artificial intelligence system including a prediction processor. The first and second GUI objects are updated using the predicted first and second data, respectively.

### CROSS-REFERENCE

This application claims the benefit of U.S. Prov. Appl. No. 63/603,530, filed Nov. 28, 2023, the entire contents of which are incorporated herein by this reference.

### TECHNICAL FIELD

The disclosed exemplary embodiments relate to computer-implemented systems and methods and, in particular, to automatic generation of contextualized data visualizations.

### BACKGROUND

Software applications can be used to provide visualizations of data. These visualizations may be in the form of charts, such as line charts, bar charts, pie charts, and so forth. The software application may be web-based and accessible by client devices via a web-based interface associated with the software application. In other cases, the software application can be a compiled program that is executed on the client device.

### SUMMARY

The following summary is intended to introduce the reader to various aspects of the detailed description, but not to define or delimit any invention.

In at least one broad aspect, there is provided a system for generating contextualized data visualizations, the system comprising: at least one database comprising first data associated with an identifier and second data associated with the identifier; and a computer operatively coupled to the at least one database, the computer comprising a memory and a processor configured to: provide a first graphical user interface (GUI) object based on the first data; provide a second GUI object based on the second data; receive a single selection of a scenario; in response to the single selection of the scenario, model a first impact of the scenario on the first data to generate predicted first data; in response to the single selection of the scenario, separately model a second impact of the scenario on the second data to generate predicted second data; generate an updated first GUI object using the predicted first data; generate an updated second GUI object using the predicted second data; and provide the updated first GUI object and the updated second GUI object for display.

In some cases, the processor is further configured to: receive a point selection, the point selection relating to a first data point of the predicted first data at a first time; determine a second data point of the predicted second data at the first time; and provide a first indicator associated with the first data point in the updated first GUI object and a second indicator associated with the second data point in the updated second GUI object.

In another broad aspect, there is provided a method of generating contextualized data visualization of first data associated with an identifier and second data associated with the identifier, the method comprising: providing a first graphical user interface (GUI) object based on the first data; providing a second GUI object based on the second data; receiving a single selection of a scenario; in response to the single selection of the scenario, modeling a first impact of the scenario on the first data to generate predicted first data; in response to the single selection of the scenario, separately modeling a second impact of the scenario on the second data to generate predicted second data; generating an updated first GUI object using the predicted first data; generating an updated second GUI object using the predicted second data; and providing the updated first GUI object and the updated second GUI object for display.

In some cases, the method further comprises: receiving a point selection, the point selection relating to a first data point of the predicted first data at a first time; determining a second data point of the predicted second data at the first time; and providing a first indicator associated with the first data point in the updated first GUI object and a second indicator associated with the second data point in the updated second GUI object.

In some cases, the predicted first data and the predicted second data share common time bounds.

In some cases, the updated first GUI object and the updated second GUI object are generated to have common time bounds.

In some cases, the updated first GUI object includes a first confidence indication, wherein the updated second GUI object includes a second confidence indication different than the first confidence indication.

In some cases, the first confidence indication is based on the first model and the second confidence indication is based on the second model.

In some cases, the at least one database comprises a first database and a second database, wherein the first data is stored in the first database, wherein the second data is stored in the second database.

In some cases, the computer further comprises an input device and a display, wherein the user selection is received via the input device, further comprising displaying the updated first GUI object and the updated second GUI object on the display.

In some cases, the system further comprises a second computer operatively coupled to the computer, the second computer comprising a second memory, a second processor, an input device and a display, wherein the user selection is received via the input device, further comprising displaying the updated first GUI object and the updated second GUI object on the display.

In some cases, the first impact and the second impact are modeled using at least one model specific to the scenario.

In some cases, the first impact is modeled using a first model of the at least one model specific to the first data, and the second impact is modeled using a second model of the at least one model specific to the second data.

According to some aspects, the present disclosure provides a non-transitory computer-readable medium storing computer-executable instructions. The computer-executable instructions, when executed, configure a processor to perform any of the methods described herein.

### BRIEF DESCRIPTION OF THE DRAWINGS

The drawings included herewith are for illustrating various examples of articles, methods, and systems of the present specification and are not intended to limit the scope of what is taught in any way. In the drawings:

FIG. 1A is a schematic block diagram of a system for generating contextualized data visualizations in accordance with at least some embodiments;

FIG. 1B is a schematic block diagram of a computing element of FIG. 1A, including a dashboard module configured to generate data for contextualized visualizations, in accordance with at least some embodiments;

FIG. 2 is a block diagram of a computer in accordance with at least some embodiments;

FIG. 3 is a flowchart diagram of an example method of generating contextualized data visualizations in accordance with at least some embodiments;

FIGS. 4A to 4C illustrate example user interfaces in accordance with at least some embodiments; and

FIG. 5 illustrates an example user interface in accordance with at least some embodiments.

### DETAILED DESCRIPTION

Visualizations of data may be helpful to assist users in understanding underlying data. By presenting the data in a visual form for evaluation by humans, the humans can be assisted to identify trends in data, inflection points, and other insights.

Most often, data visualization has presented historical data and relied on the user to draw their own conclusions on future trends. However, it is also possible to generate predictions and present those predictions together with historical data, to provide even greater insights to users. Predictions can be computed using a variety of models, including statistical and machine learning models.

Even greater insights can be gleaned from visualizations if the user is provided with different views of the same data, related data, or both. A user may be better able to understand the impact of a future action if the user can evaluate the predicted impact of that future action in a variety of different contexts. For example, a mechanical engineer may wish to evaluate the impact of using a different material on the load bearing capability of a part while also evaluating the impact of using that material on the cost of producing that part. Or, in another example, a manager may wish to evaluate the impact of hiring an additional employee on predicted sales and also on personnel cost.

Conventionally, it has been possible to generate discrete visualizations for such scenarios and to render them in chart form, for example. However, it can be difficult for a user to quickly and reliably grasp the impact of a single action in multiple different contexts without manual and error-prone updating of the underlying data. This difficulty is exacerbated considerably when dealing with future predictions. The predictive model in one context may differ from the predictive model in another context, adding additional complexity and making it difficult to present visually.

The described embodiments provide for contextualized visualizations, that enable users to add and explore future scenarios. With each update, multiple visualizations can be updated concurrently and consistently, to enable the user to see and evaluate the impact of each scenario in various contexts.

Users can also navigate through each visualization and identify corresponding points in other visualizations. For instance, selection of a date in a first graph will automatically identify corresponding dates in other graphs.

Users can enable or disable scenarios, or even future predictions.

Each of the data visualizations may be informed by historical data, future predicted data based on one or more models, and the available scenarios.

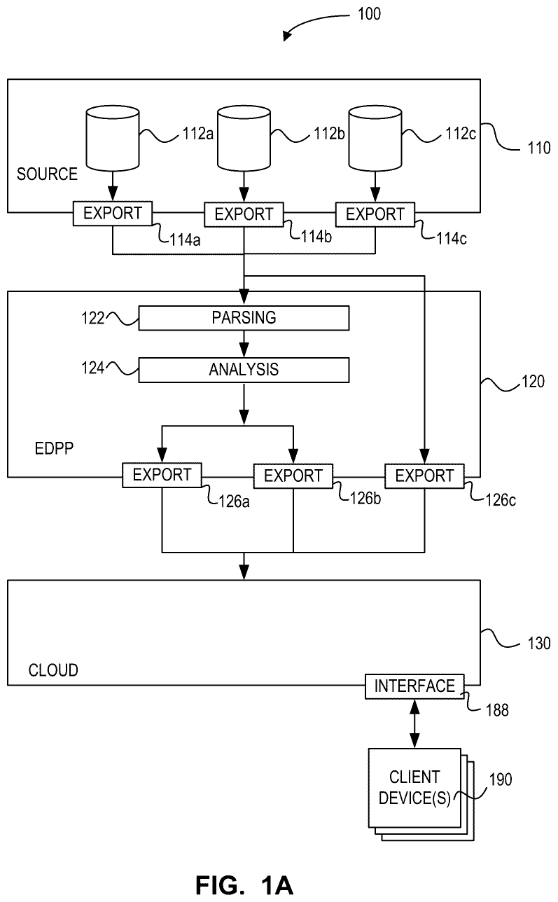

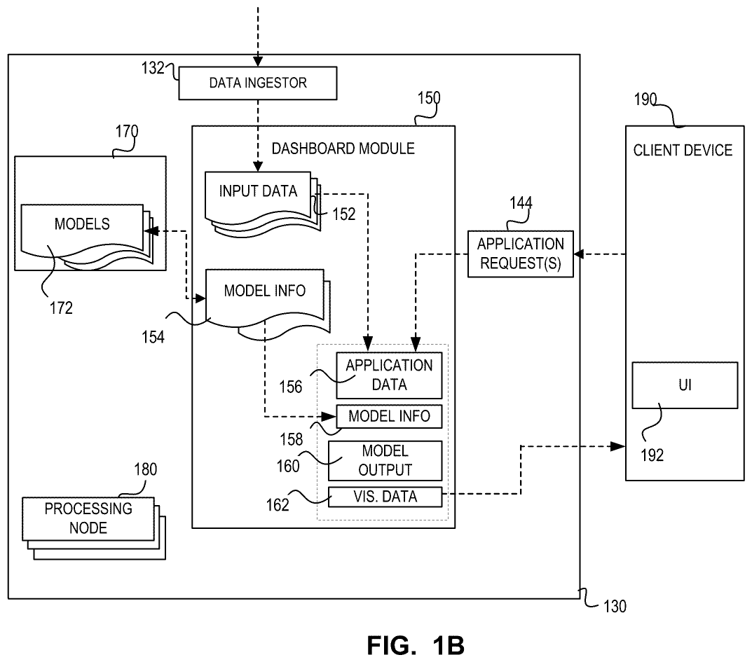

Referring now to FIG. 1A, there is illustrated a block diagram of an example computing system, in accordance with at least some embodiments. Computing system 100 has a source database system 110, an enterprise data provisioning platform (EDPP) 120 operatively coupled to the source database system 110, and a computing element130 that is operatively coupled to the EDPP 120. In some cases. this computing system 100 is provided for automated data processing of data sets, including computing a time series of predicted characteristics of assets identified within the large data sets.

Source database system 110 has one or more databases, of which three are shown for illustrative purposes: database 112a, database 112b and database 112c. One or more the databases of the source database system 110 may contain confidential information that is subject to restrictions on export. One or more export modules 114a, 114b, 114c may periodically (e.g., daily, weekly, monthly, etc.) export data from the databases 112a, 112b, 112c to EDPP 120. In some instances, the data is exported on an ad hoc basis. In some cases, the export data may be exported in the form of comma separated value (CSV) data, however other formats may also be used.

EDPP 120 receives source data exported by the export modules 114 of source database system 110, processes it and exports the processed data to an application database within the computing element130. For example, a parsing module 122 of EDPP 120 may perform extract, transform and load (ETL) operations on the received source data.

In many environments, access to the EDPP may be restricted to relatively few users, such as administrative users. However, with appropriate access permissions, data relevant to an application or group of applications (e.g., a client application) may be exported via reporting and analysis module 124 or an export module 126. In particular, parsed data can then be processed and transmitted to the computing element130 by a reporting and analysis module 124. Alternatively, one or more export modules 126a, 126b, 126c can export the parsed data to the computing element130.

In some cases, there may be confidentiality and privacy restrictions imposed by governmental, regulatory, or other entities on the use or distribution of the source data. These restrictions may prohibit confidential data from being transmitted to computing systems that are not “on-premises” or within the exclusive control of an organization, for example, or that are shared among multiple organizations, as is common in a cloud-based environment. In particular, such privacy restrictions may prohibit the confidential data from being transmitted to distributed or cloud-based computing systems, where it can be processed by machine learning systems, without appropriate anonymization or obfuscation of personal identifiable information (PII) in the confidential data. Moreover, such “on-premises” systems typically are designed with access controls to limit access to the data, and thus may not be resourced or otherwise suitable for use in broader dissemination of the data. In some cases, to comply with such restrictions, one or more module of EDPP 120 may “de-risk” data tables that contain confidential data prior to transmission to computing element130. In some cases, this de-risking process may obfuscate or mask elements of confidential data, or may exclude certain elements, depending on the specific restrictions applicable to the confidential data. The specific type of obfuscation, masking or other processing is referred to as a “data treatment.”

The computing element130 includes an interface 188, which facilitates data communication with one or more client devices.

Referring now to FIG. 1B, there is illustrated a block diagram of a computing element 130, showing greater detail of the elements of the cloud-based computing cluster, which may be implemented by computing nodes of the cluster that are operatively coupled.

The components of the computing element130 include a data ingestor 132, a dashboard module 150, and a model repository 170. In some cases, the data ingestor 132, the dashboard module 150, and the configuration repository 170 are implemented as one or more processing nodes 180 in the cloud-based computing cluster. In some cases, these components are implemented as virtual machines within the cloud-based computing cluster.

The dashboard module 150 processes and responds to one or more application request 144, e.g., from a dashboard UI 192.

An application request 144 may identify a type of data to be retrieved to update one or more graphical user interface (GUI) object, such as a visualization chart. An application request may also identify one or more scenarios to be executed to generate predicted future data, along with the supporting parameters (e.g., start data or time for the scenario).

The dashboard module also receives input data 152, which can be processed to provide application data 156, such as historical data to be used for generating GUI objects. Input data 152 can be data received from EDPP 120, while, in other embodiments, the input data may originate from other sources and databases. That is, in some embodiments, computing element 130 may operate standalone without a source database 110 and/or EDPP 120, in which case it may receive data from other databases or sources.

The dashboard module 150 is also configured to retrieve model information 154 from a model repository 170. The configuration repository 170 stores one or more model configurations 172.

The dashboard module 150 is configured to, for each model applicable to a selected scenario, process the application data using the model configuration to generate the model output to be used to update the GUI object or objects according to the selected scenario. The processing may be performed by one or more processing nodes 180. The output of the model is the data for generating the visualization, which is transmitted to the dashboard UI 192, which can then render the update GUI object or objects using the data. In some embodiments, the dashboard module 150 may render the GUI objects and transmit them as, e.g., images for display in the dashboard UI 192.

Client device 190 executes the UI 192=to connect to the dashboard module 150 over a data network connection, such as an Internet connection. The client device 190, via the UI 192, interacts with the dashboard module 150 to send application requests 144 to the dashboard module 150.

In some alternate embodiments, both the dashboard UI 192 and the dashboard module 150 can be executed by the client device 190.

It will be appreciated that, while the components shown in FIG. 1B for the computing element130 can be implemented with the system 100 in FIG. 1A, in some other cases, the components shown in FIG. 1B are instead implemented in an isolated computing server system. In other words, the components shown in FIG. 1B can be implemented as a processing node 180 without the EDPP 120 and the source database system 110.

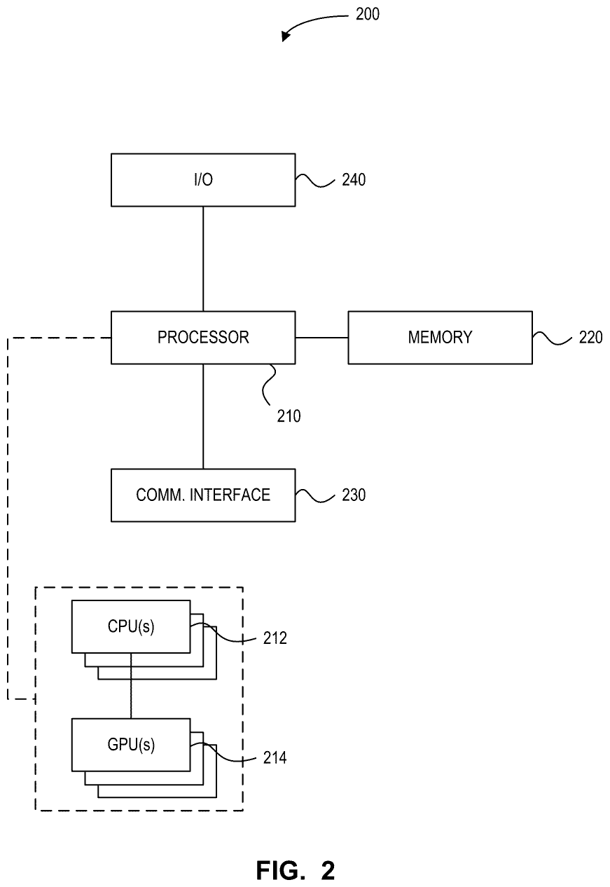

Referring now to FIG. 2, there is illustrated a simplified block diagram of a computer in accordance with at least some embodiments. Computer 200 is an example implementation of a computer such as source database system 110, EDPP 120, processing node 180 of FIG. 1A. Computer 200 has at least one processor 210 operatively coupled to at least one memory 220, at least one communications interface 230 (also herein called a network interface), and at least one input/output device 240.

The at least one memory 220 includes a volatile memory that stores instructions executed or executable by processor 210, and input and output data used or generated during execution of the instructions. Memory 220 may also include non-volatile memory used to store input and/or output data—e.g., within a database—along with program code containing executable instructions.

Processor 210 may transmit or receive data via communications interface 230, and may also transmit or receive data via any additional input/output device 240 as appropriate.

In some cases, the processor 210 includes a system of central processing units (CPUs) 212. In some other cases, the processor includes a system of one or more CPUs and one or more Graphical Processing Units (GPUs) 214 that are coupled together. For example, the prediction processor 166 executes machine learning computations on CPU and GPU hardware, such as the system of CPUs 212 and GPUs 214.

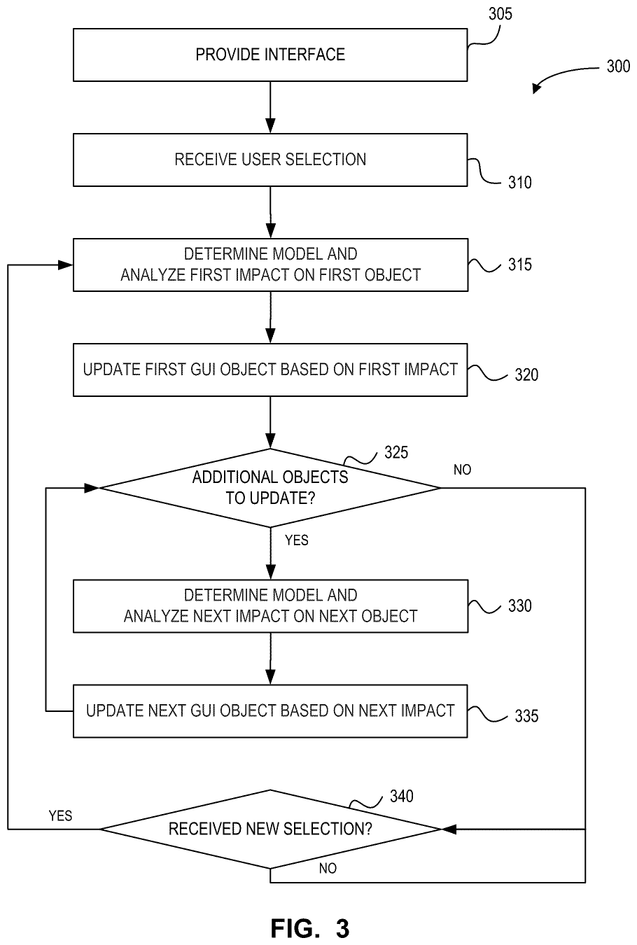

Referring to FIG. 3, an example method 300 is provided, which is executable by a processor, such as a processor for a processing node that operates the dashboard module or, in some other cases, by the client device. The method includes the following operations.

Block 305: Optionally, provide the interface to the client device. In cases where the dashboard module is executed by a device other than the client device, this may include transferring the dashboard UI (e.g., UI 192) to the client device for execution. In cases where the dashboard module is executed on the client device, this may include loading the dashboard UI. In either event, the interface displayed on the client device will have a first GUI object based on first data from at least one database and a second GUI object based on second data from the at least one database. The interface may also contain additional GUI objects based on additional data from the at least one database.

The first data, second data and additional data are each associated with an identifier, which may be a user identifier or other identifier in common. In this way, when the first data, second data and/or additional data originate from separate databases, or separate database tables, the corresponding GUI objects can be related to each other. The interface may also contain a scenario selector interface elements, such as a button, link or drop-down dialog.

Block 310: Receive selection of a scenario to be analyzed in relation to one or more GUI objects. For instance, the selection may correspond to a user selection of the scenario selector.

Block 315: Determine which model is to be used to model a first impact on the first data of the selected scenario identified at block 310, and process the application data relating to the first GUI object using the determined model to model a first impact of the scenario on the first data to generate predicted first data for updating the first GUI object. The model may be selected from a plurality of models, at least some of which may be specific to the selected scenario. For example, if the selected scenario relates to a choice of some thing, one or more models may relate to the impact of that thing on the predicted future data.

Block 320: provide the output data to the UI for updating the first GUI object.

Block 325: determine whether there is an additional GUI object to be updated and, if yes, proceed to block 330. Otherwise, proceed to block 340.

Block 330: Determine which model is to be used to model an additional impact (e.g., second impact) on the respective additional data (e.g., second data) of the selected scenario identified at block 310. In some cases, the model determined will be different than model determined at block 315, however the model may still be specific to the selected scenario.

In other cases, the model may be the same as at block 315. Process the application data relating to the respective additional GUI object (e.g., second GUI object) using the determined model to model a respective additional impact (e.g., second impact) of the scenario on the respective additional data (e.g., second data) to generate respective additional predicted data (e.g., predicted second data) for updating the respective additional GUI object (e.g., second GUI object).

Block 335: provide the output data to the UI for updating the additional GUI object, and return to block 325 to determine whether there are any additional GUI objects to be updated.

Block 340: determine whether a new selection has been received, corresponding to a new scenario to be analyzed in relation to the one or more GUI objects. If no, then wait for further input. If yes, return to block 315 to process the new selection.

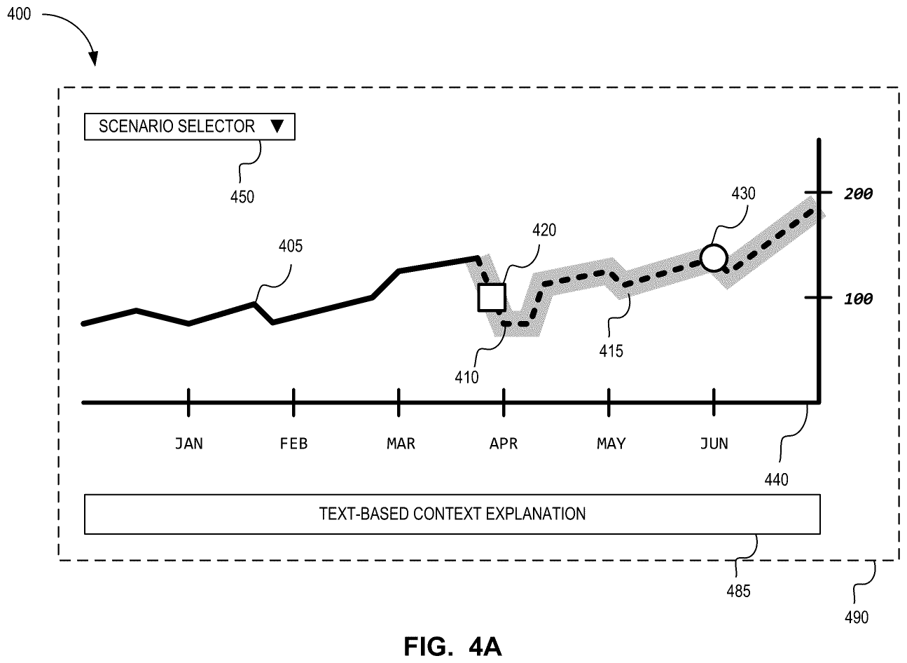

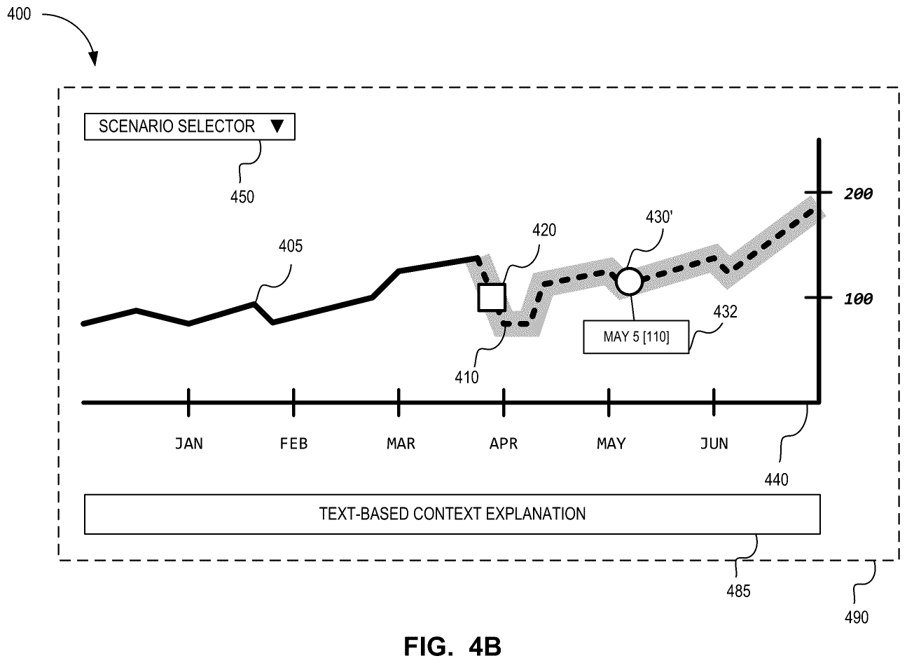

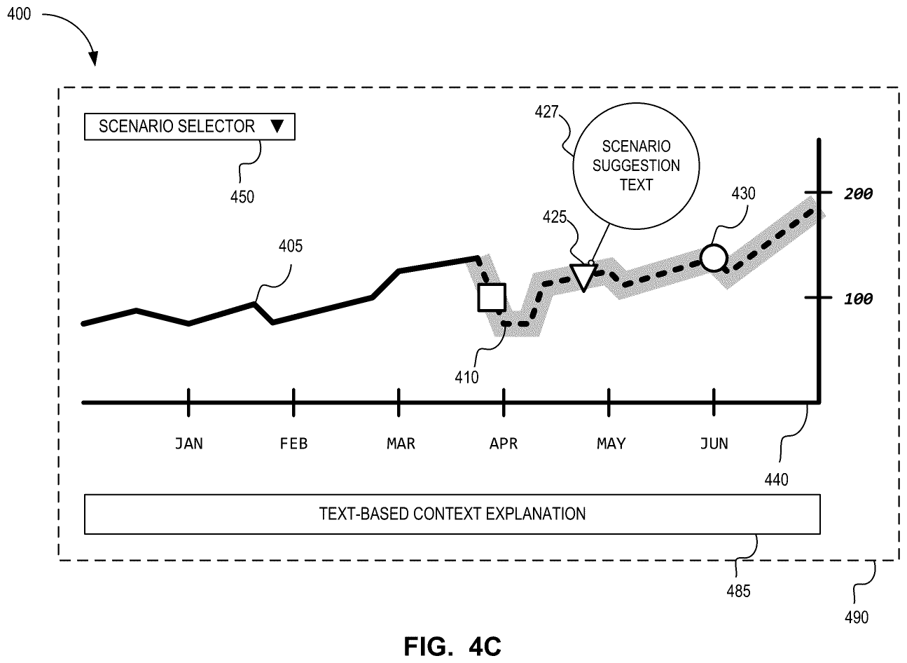

Referring to FIG. 4A, there is shown an example GUI object containing a data visualization in accordance with at least some embodiments. GUI object 400 is a line chart displayed on a display 490.

The line chart includes historical data represented by a solid line 405, and predicted data represented by a dashed line 410. In some cases, predicted data may have a confidence indication 415, which indicates a range within which the predictions may have a reasonable degree of confidence. The degree of confidence may be configurable, and may depend on the model used to generate the predicted data, such that data produced by difference models may have smaller or larger confidence indications (narrower or thicker), as the case may be.

The line chart has axes 440. In some cases, the GUI object may relate to time series data, in which case the horizontal axis can relate to time (e.g., months), while the vertical axis may relate to some aspect of the data being displayed (e.g., amount, quantity, scale, etc.).

In many cases, a first and second GUI object may each relate to time series data, in which case the predicted first data and the predicted second data share common time bounds. Accordingly, the updated first GUI object and the updated second GUI object can be generated to have common time bounds on the time series axis (e.g., horizontal axis).

A scenario selector 450 is provided to allow user selection of a scenario to be executed to generate one or more predicted data.

A scenario start indicator 420 may be provided on the GUI object. The scenario start indicator 420 may be interactive, and can be moved along the predicted data line 410 by the user to select a start time for applying a selected scenario, e.g., using scenario selector 450.

In one example, a user may select a scenario using scenario selector 450, then move the scenario start indicator 420 to a desired date and/or time. A start button may be provided (not shown), which the user can select to initiate the processing of the scenario, following which the GUI object 400 (along with any other GUI objects being displayed) will be updated.

A text-based context explanation field 485 can be provided, which can contain explanatory text relating to the GUI object, selected scenario, or more.

A query indicator 430 can be provided, which can be used to obtain a point selection by a user. The point selection can relate to a selected data point on the historical data line 405 or the predicted data line 410.

Referring to FIG. 4B, a second view of the example GUI object 400 of FIG. 4A is shown. In the second view, the query indicator 430 has been moved to a different point, and a contextual dialog box 432 is displayed showing details of the selected data point.

Referring to FIG. 4C, a third view of the example GUI object 400 of FIG. 4A is shown. In the third view, a suggestion indicator 425 is displayed, along with a suggestion dialog box 427. The suggestion indicator 425 can be automatically displayed to highlight data points of interest, or suggested data points for initiating a scenario.

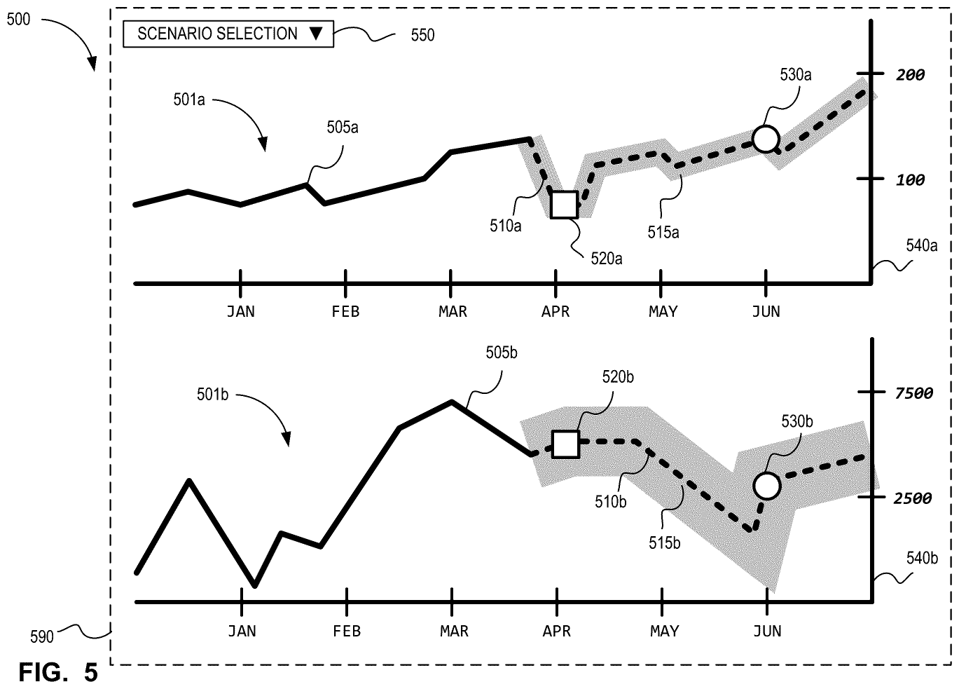

Referring to FIG. 5, there is shown an example interface including first and second GUI objects, each containing a data visualization in accordance with at least some embodiments. Interface 500 has a first GUI object 501a, which generally corresponds to GUI object 400, and a second GUI object 501b, which differs from first GUI object 501a.

Both first and second GUI objects 501a and 501b share common time series bounds, but have different vertical axes. Historical data line 505a differs from historical data line 505b, as does predicted data line 510a from predicted data line 510b. In addition, the confidence indication 515b for predicted data line 510b is considerably larger than the confidence indication 515a for predicted data line 510a, suggesting a lower degree of confidence.

Scenario start indicators 520a and 520b both appear aligned on the time axis. Selection and movement of either scenario start indicator 520a or 520b will result in a corresponding movement of the other scenario start indicator, such that the scenario start indicators are always vertically aligned.

Similarly, query indicator 530a and 530b both appear aligned on the time axis. Selection and movement of either query indicator 530a or 530b will cause the interface to determine a corresponding data point at the same time, and result in a corresponding movement of the other query indicator, such that the query indicators are always vertically aligned. Similar alignment of the suggestion indicator (not shown) can also be performed.

Generally, the described embodiments allow for a contextualized dashboard, which links multiple GUI objects together. The GUI objects provide indications of historical data and predictive elements in a single view, allowing a user to quickly and easily assess the predicted impact of actions or scenarios in multiple contexts.

Various systems or processes have been described to provide examples of embodiments of the claimed subject matter. No such example embodiment described limits any claim and any claim may cover processes or systems that differ from those described. The claims are not limited to systems or processes having all the features of any one system or process described above or to features common to multiple or all the systems or processes described above. It is possible that a system or process described above is not an embodiment of any exclusive right granted by issuance of this patent application. Any subject matter described above and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth to provide a thorough understanding of the subject matter described herein. However, it will be understood by those of ordinary skill in the art that the subject matter described herein may be practiced without these specific details. In other instances, well-known methods, procedures, and components have not been described in detail so as not to obscure the subject matter described herein.

The terms “coupled” or “coupling” as used herein can have several different meanings depending in the context in which these terms are used. For example, the terms coupled or coupling can have a mechanical, electrical or communicative connotation. For example, as used herein, the terms coupled or coupling can indicate that two elements or devices are directly connected to one another or connected to one another through one or more intermediate elements or devices via an electrical element, electrical signal, or a mechanical element depending on the particular context. Furthermore, the term “operatively coupled” may be used to indicate that an element or device can electrically, optically, or wirelessly send data to another element or device as well as receive data from another element or device.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Terms of degree such as “substantially”, “about”, and “approximately” as used herein mean a reasonable amount of deviation of the modified term such that the result is not significantly changed. These terms of degree may also be construed as including a deviation of the modified term if this deviation would not negate the meaning of the term it modifies.

Any recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the result is not significantly changed.

Some elements herein may be identified by a part number, which is composed of a base number followed by an alphabetical or subscript-numerical suffix (e.g., 112a, or 112b). All elements with a common base number may be referred to collectively or generically using the base number without a suffix (e.g., 112).

The systems and methods described herein may be implemented as a combination of hardware or software. In some cases, the systems and methods described herein may be implemented, at least in part, by using one or more computer programs, executing on one or more programmable devices including at least one processing element, and a data storage element (including volatile and non-volatile memory and/or storage elements). These systems may also have at least one input device (e.g., a pushbutton keyboard, mouse, a touchscreen, and the like), and at least one output device (e.g., a display screen, a printer, a wireless radio, and the like) depending on the nature of the device. Further, in some examples, one or more of the systems and methods described herein may be implemented in or as part of a distributed or cloud-based computing system having multiple computing components distributed across a computing network. For example, the distributed or cloud-based computing system may correspond to a private distributed or cloud-based computing cluster that is associated with an organization. Additionally, or alternatively, the distributed or cloud-based computing system be a publicly accessible, distributed or cloud-based computing cluster, such as a computing cluster maintained by Microsoft Azure™, Amazon Web Services™, Google Cloud™, or another third-party provider. In some instances, the distributed computing components of the distributed or cloud-based computing system may be configured to implement one or more parallelized, fault-tolerant distributed computing and analytical processes, such as processes provisioned by an Apache Spark™ distributed, cluster-computing framework or a Databricks™ analytical platform. Further, and in addition to the CPUs described herein, the distributed computing components may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle.

Some elements that are used to implement at least part of the systems, methods, and devices described herein may be implemented via software that is written in a high-level procedural language such as object-oriented programming language. Accordingly, the program code may be written in any suitable programming language such as Python or Java, for example. Alternatively, or in addition thereto, some of these elements implemented via software may be written in assembly language, machine language or firmware as needed. In either case, the language may be a compiled or interpreted language.

At least some of these software programs may be stored on a storage media (e.g., a computer readable medium such as, but not limited to, read-only memory, magnetic disk, optical disc) or a device that is readable by a general or special purpose programmable device. The software program code, when read by the programmable device, configures the programmable device to operate in a new, specific, and predefined manner to perform at least one of the methods described herein.

Furthermore, at least some of the programs associated with the systems and methods described herein may be capable of being distributed in a computer program product including a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g., downloads), media, digital and analog signals, and the like. The computer usable instructions may also be in various formats, including compiled and non-compiled code.

While the above description provides examples of one or more processes or systems, it will be appreciated that other processes or systems may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be revisited.

1. A system for generating contextualized data visualizations, the system comprising:
at least one database comprising first data associated with an identifier and second data associated with the identifier; and
a computer operatively coupled to the at least one database, the computer comprising a memory and a processor configured to:
provide a first graphical user interface (GUI) object based on the first data;
provide a second GUI object based on the second data;
receive a single selection of a scenario;
in response to the single selection of the scenario, model a first impact of the scenario on the first data to generate predicted first data;
in response to the single selection of the scenario, separately model a second impact of the scenario on the second data to generate predicted second data;
generate an updated first GUI object using the predicted first data:
generate an updated second GUI object using the predicted second data; and
provide the updated first GUI object and the updated second GUI object for display.

2. The system of claim 1, wherein the predicted first data and the predicted second data share common time bounds.

3. The system of claim 1, wherein the updated first GUI object and the updated second GUI object are generated to have common time bounds.

4. The system of claim 1, wherein the updated first GUI object includes a first confidence indication, wherein the updated second GUI object includes a second confidence indication different than the first confidence indication.

5. The system of claim 4, wherein the first confidence indication is based on the first model and the second confidence indication is based on the second model.

6. The system of claim 1, wherein the processor is further configured to:
receive a point selection, the point selection relating to a first data point of the predicted first data at a first time;
determine a second data point of the predicted second data at the first time; and
provide a first indicator associated with the first data point in the updated first GUI object and a second indicator associated with the second data point in the updated second GUI object.

7. The system of claim 1, wherein the at least one database comprises a first database and a second database, wherein the first data is stored in the first database, wherein the second data is stored in the second database.

8. The system of claim 1, wherein the computer further comprises an input device and a display, wherein the user selection is received via the input device, further comprising displaying the updated first GUI object and the updated second GUI object on the display.

9. The system of claim 1, further comprising a second computer operatively coupled to the computer, the second computer comprising a second memory, a second processor, an input device and a display, wherein the user selection is received via the input device, further comprising displaying the updated first GUI object and the updated second GUI object on the display.

10. The system of claim 1, wherein the first impact and the second impact are modeled using at least one model specific to the scenario.

11. The system of claim 10, wherein the first impact or the second impact are modeled using a machine learning model.

12. A method of generating contextualized data visualization of first data associated with an identifier and second data associated with the identifier, the method comprising:
providing a first graphical user interface (GUI) object based on the first data;
providing a second GUI object based on the second data;
receiving a single selection of a scenario;
in response to the single selection of the scenario, modeling a first impact of the scenario on the first data to generate predicted first data;
in response to the single selection of the scenario, separately modeling a second impact of the scenario on the second data to generate predicted second data;
generating an updated first GUI object using the predicted first data;
generating an updated second GUI object using the predicted second data; and
providing the updated first GUI object and the updated second GUI object for display.

13. The method of claim 12, wherein the predicted first data and the predicted second data share common time bounds.

14. The method of claim 12, wherein the updated first GUI object and the updated second GUI object are generated to have common time bounds.

15. The method of claim 12, wherein the updated first GUI object includes a first confidence indication, wherein the updated second GUI object includes a second confidence indication different than the first confidence indication.

16. The method of claim 15, wherein the first confidence indication is based on the first model and the second confidence indication is based on the second model.

17. The method of claim 12, further comprising:
receiving a point selection, the point selection relating to a first data point of the predicted first data at a first time;
determining a second data point of the predicted second data at the first time; and
providing a first indicator associated with the first data point in the updated first GUI object and a second indicator associated with the second data point in the updated second GUI object.

18. The method of claim 12, wherein the first impact and the second impact are modeled using at least one model specific to the scenario.

19. The method of claim 12, wherein the first impact is modeled using a first model of the at least one model specific to the first data, and the second impact is modeled using a second model of the at least one model specific to the second data.

20. A non-transitory computer readable medium storing computer executable instructions which, when executed by at least one computer processor, cause the at least one computer processor to carry out the method of claim 12.
